(19) United States
(12) Patent Application Publication
(10) Pub. No.: US 2005/0035732 A1
(43) Pub. Date: Feb. 17, 2005

(54) Brushless dc motor having a speed control circuit

(75) Inventors: Alex Horng, Kaohsiung (TW); Ching-Sheng Hong, Kaohsiung (TW); Ta-Lun Ko, Kaohsiung Hsien (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 10/657,229

(22) Filed: Sep. 9, 2003

(30) Foreign Application Priority Data
Aug. 12, 2003 (TW) 92122150

(51) Int. Cl. H02P 7/00

(52) U.S. Cl. 318/434

(57) ABSTRACT

A brushless dc motor includes a fan motor drive circuit, an over-current-detecting/current-limiting circuit and a multi-functional speed control circuit. The fan motor drive circuit is connected to the over-current-detecting/current-limiting circuit which is further connected to the multi-functional speed control circuit. The over-current-detecting/current-limiting circuit is adapted to detect a rotational speed and an over-current. Detecting an over-current, the over-current-detecting/current-limiting circuit controls a current at a low voltage level for passing through the fan motor drive circuit and inadequate to destroy it. The multi-functional speed control circuit sends a predetermined speed signal to control the over-current-detecting/current-limiting circuit for carrying out speed control of the brushless dc motor.

### BACKGROUND OF THE INVENTION

1. Field of the Invention

The present invention is related to a brushless dc motor having a speed control circuit. More particularly, the present invention is related to a speed control circuit incorporating into a brushless dc motor, and connecting to a current limiting circuit suitable for controlling rotational speed of the brushless dc motor.

2. Description of the Related Art

Referring to FIG. 1, it illustrates a schematic block diagram of a dual current-limiting circuit for a brushless dc fan motor. The brushless dc fan motor includes a fan motor drive circuit 10 and a dual current-limiting circuit 20.

The fan motor drive circuit 10 includes a Hall voltage amplifier circuit 11, a phase inverter circuit 12, and a motor coil drive circuit 13. The Hall voltage amplifier circuit 11 is used to amplify a weak Hall voltage and outputted it to the phase inverter circuit 12. The phase inverter circuit 12 inverts the phase of the amplified Hall voltage of the Hall voltage amplifier circuit 11 at 180°and then outputs it to the motor coil drive circuit 13 so as to alternatively actuate the motor coil to rotate a motor rotor.

The dual current-limiting circuit 20 includes an over-current detective circuit 21, a rotational detective circuit 22, and a current-limiting circuit 23. The over-current detective circuit 21 comprises a resistor and produces a first voltage signal to determine whether the motor has been input over current. The rotational detective circuit 22 retrieves the amplified Hall voltage of the Hall voltage amplifier circuit 11, and a rectifier/integral circuit is used to produce a second voltage signal (high or low voltage level) to determine whether the motor is operated in normal. The current-limiting circuit 23 is used to turn on or off current-limiting function depending upon the two voltage signals supplied from the over-current detective circuit 21 and the rotational detective circuit 22 to thereby control the phase inverter circuit 12 of the fan motor drive circuit 10. Current passing through the fan motor drive circuit 10 is suppressed at low voltage level which is inadequate to destroy it. The current-limiting circuit 23 comprises a comparator being used to calculate the two voltage signals of the over-current detective circuit 21 and the rotational detective circuit 22 and then subsequently to control turning on or off current-limiting function.

Referring to FIG. 2, it illustrates a schematic block diagram of a conventional fan motor having a PWM control circuit. The fan motor 1 is serially connected to a PWM control circuit 30 and a thermal sensor element 31 so that the rotational speed of the fan motor 1 is controlled by PWM signals according to ambient temperature detected by the thermal sensor element 31. Since the PWM control circuit 30 is located in an outer control system (not shown) and connected to a fan motor drive circuit of the fan motor, the fan motor drive circuit is controlled by duty cycle supplied from the PWM control circuit.

Referring to FIG. 3, it illustrates a schematic diagram of rotational speed of a fan motor in FIG. 2 in relation to ambient temperature. The fan motor 1 has a multiple speed control circuit which is contained with at least three predetermined speeds S0, S1 and S2 at various ambient temperatures T0, T1 and T2.

Referring again to FIGS. 2 and 3, as the thermal sensor element 31 is detecting an ambient temperature T1, the rotational speed of the fan motor 1 is on the increase of S1. Also, as the thermal sensor element 31 is detecting an ambient temperature T2, the rotational speed of the fan motor 1 is on the increase of S2. However, the change of rotational speed of the fan motor 1 is imprecise due to the difference of duty cycle between the PWM control circuit 30 of the outer control system and the fan motor drive circuit of the fan motor 1. Namely, the rotational speed of the fan motor 1 has a previous adjustment and an increase of S1 or S2 (shading line, shown in FIG. 3) even if the thermal sensor element 31 does not detect an increasing temperature of T1 or T2. Contrarily, the rotational speed of the fan motor 1 has a delay adjustment and a decrease of S1 or S2 (shading line, shown in FIG. 3) even if the thermal sensor element 31 does not detect a decreasing temperature of T1 or T2.

Consequently, PWM speed control signals supplied from an outer control system is unsuitable for inputting into a brushless dc motor having a speed control circuit.

The present invention intends to provide a brushless dc motor having a fan motor drive circuit serially connected with an over-current detective/current-limiting circuit and a multi-functional speed control circuit multi-functional speed control circuit generates signals to control the over-current detective/limiting circuit, thereby controlling the fan motor drive circuit in multiple speed stages in such a way to mitigate and overcome the above problem.

### SUMMARY OF THE INVENTION

The primary objective of this invention is to provide a brushless dc motor having a speed control circuit, which includes a fan motor drive circuit serially connected with an over-current detective/current-limiting circuit and a multi-functional speed control circuit. The multi-functional speed control circuit generates signals to control the over-current detective/current-limiting circuit, thereby controlling the fan motor drive circuit in multiple speed stages.

The secondary objective of this invention is to provide the brushless dc motor having a speed control circuit, which includes a fan motor drive circuit serially connected with an over-current detective/current-limiting circuit and a multi-functional speed control circuit. The entire circuitry structure of the speed control circuit is simplified by incorporating the multi-functional speed control circuit into the fan motor drive circuit.

The brushless dc motor in accordance with the present invention includes a fan motor drive circuit, an over-current-detecting/current-limiting circuit and a multi-functional speed control circuit. The fan motor drive circuit is connected to the over-current-detecting/current-limiting circuit which is further connected to the multi-functional speed control circuit. The over-current-detecting/current-limiting circuit is adapted to detect a rotational speed and an over-current. Detecting an over-current, the over-current-detecting/current-limiting circuit controls a current at a low voltage level for passing through the fan motor drive circuit and inadequate to destroy it. The multi-functional speed control circuit sends a predetermined speed signal to control the over-current-detecting/current-limiting circuit for carrying out speed control of the brushless dc motor.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a schematic block diagram of a dual current-limiting circuit for a brushless dc fan motor in accordance with the prior art;

FIG. 2 is a schematic block diagram of a conventional fan motor having a PWM control circuit in accordance with the prior art;

FIG. 3 is a schematic diagram of rotational speed of a fan motor in FIG. 2 in relation to ambient temperature;

FIG. 4 is a schematic block diagram of a brushless dc motor having a speed control circuit in accordance with a preferred embodiment of the present invention;

FIG. 5 is a schematic circuitry of the brushless dc motor having a speed control circuit in accordance with the preferred embodiment of the present invention; and

FIG. 6 is a schematic diagram of rotational speed of the brushless dc motor in relation to ambient temperature in accordance with the present invention.

### DETAILED DESCRIPTION OF THE INVENTION

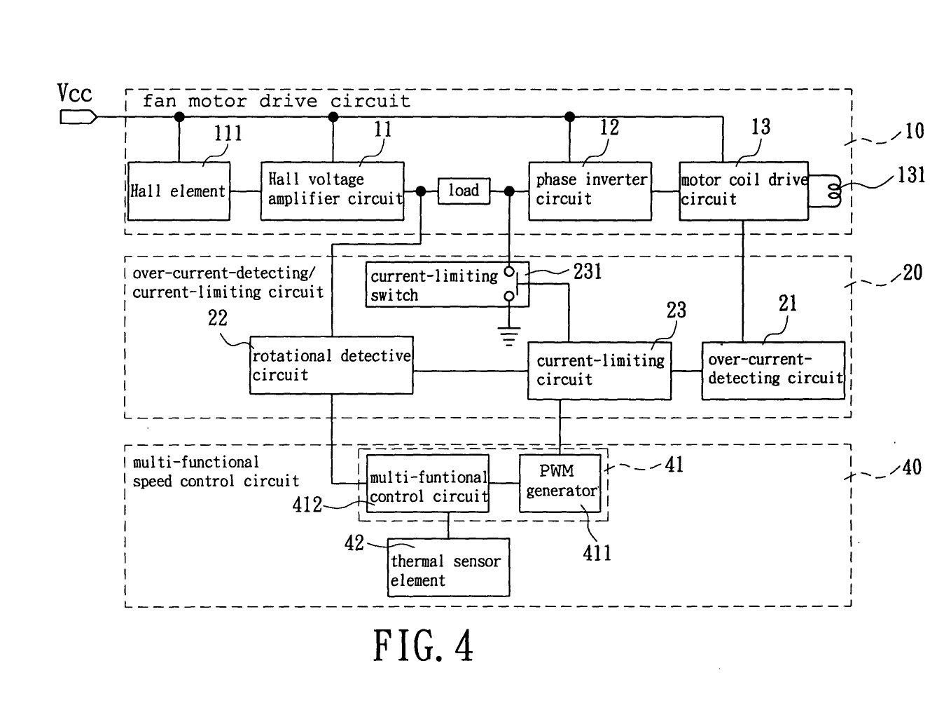

FIG. 4 illustrates a schematic block diagram of a brushless dc motor having a speed control circuit in accordance with a preferred embodiment of the present invention. Referring to FIG. 4, reference numerals of the first embodiment has applied the identical numerals of the conventional brushless dc motor. The brushless dc motor of the first embodiment has the similar configuration and same function as that of the conventional brushless dc motor and the detailed descriptions are omitted.

Referring again to FIG. 4, the brushless dc motor in accordance with the present invention includes a fan motor drive circuit 10, an over-current-detecting/current-limiting circuit 20 and a multi-functional speed control circuit 40. The fan motor drive circuit 10 is connected to the over-current-detecting/current-limiting circuit 20 which is further connected to the multi-functional speed control circuit 40. Consequently, the over-current-detecting/current-limiting circuit 20 is connected between the fan motor drive circuit 10 and the multi-functional speed control circuit 40.

Referring again to FIG. 4, the fan motor drive circuit 10 is connected to a power supply Vcc and inputted a power current for rotating a motor rotor. The over-current-detecting/current-limiting circuit 20 is adapted to detect a rotational speed and an over-current supplied from the power supply. Detecting an over-current, the over-current-detecting/current-limiting circuit 20 controls a current at a low voltage level passing through the fan motor drive circuit 10 and inadequate to destroy it. The multi-functional speed control circuit 40 sends a predetermined speed signal to control the over-current-detecting/current-limiting circuit 20 for carrying out speed control of the brushless dc motor.

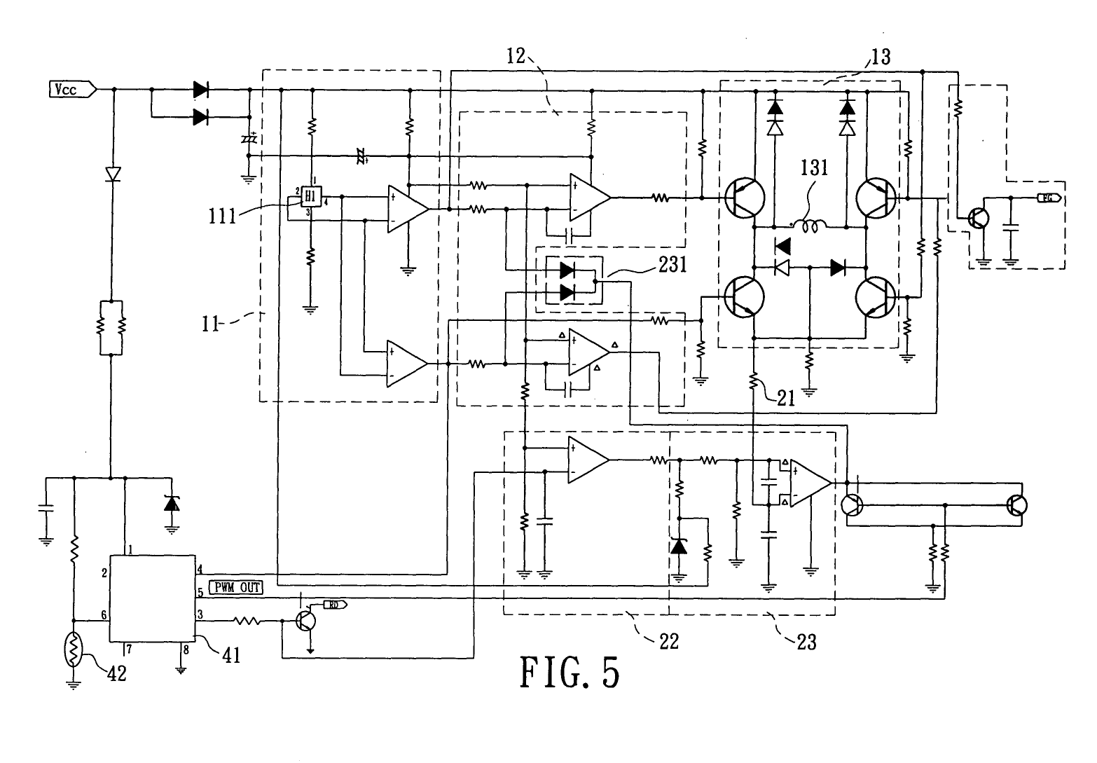

FIG. 5 illustrates a schematic circuitry of the brushless dc motor having a speed control circuit in accordance with the preferred embodiment of the present invention.

Turning now to FIGS. 4 and 5, the fan motor drive circuit 10 includes a Hall voltage amplifier circuit 11, a phase inverter circuit 12, and a motor coil drive circuit 13. The Hall voltage amplifier circuit 11 is connected to a Hall element 111 to amplify a weak Hall voltage and then outputted it to the phase inverter circuit 12. The phase inverter circuit 12 inverts the phase of the amplified Hall voltage of the Hall voltage amplifier circuit 11 at 180° and then outputs it to the motor coil drive circuit 13. Furthermore, the motor coil drive circuit 13 is connected to a motor coil 131 so that outputs of the phase inverter circuit 12 can actuate the motor coil 131 in turn to rotate a motor rotor.

Referring again to FIGS. 4 and 5, the over-current-detecting/current-limiting circuit 20 includes an over-current-detecting circuit 21, a rotational detective circuit 22 and a current-limiting circuit 23.

Referring again to FIGS. 4 and 5, the over-current-detecting circuit 21 is serially connected between the motor coil drive circuit 13 and the current-limiting circuit 23. Preferably, the over-current-detecting circuit 21 is a resistor element that sends a voltage level to the current-limiting circuit 23 for determining whether an over-current passing into the motor coil drive circuit 13.

Referring again to FIGS. 4 and 5, the rotational detective circuit 22 is serially connected between the Hall voltage amplifier circuit 11 and the current-limiting circuit 23. The rotational detective circuit 22 retrieves a voltage from the Hall voltage amplifier circuit 11 and employs a rectifier integrating circuit to generate a Hi voltage level or a Lo voltage level which is sent to the current-limiting circuit 23 for determining whether an over-current occurred.

Referring again to FIGS. 4 and 5, the current-limiting circuit 23 includes a current limiting switch 231 connected to the phase inverter circuit 12. The current-limiting circuit 23 can be actuated to turn on or off current-limiting function according to the voltage levels supplied from the over-current-detecting circuit 21 and the rotational detective circuit 22. Consequently, the phase inverter circuit 12 of the fan motor drive circuit 10 suppresses a current passing through the motor coil 131 and thus the suppressed current is inadequate to destroy the fan motor drive circuit 10. Moreover, the current-limiting circuit 23 includes a comparator to compare the two voltage levels supplied from the over-current-detecting circuit 21 and the rotational detective circuit 22. After comparing, the comparator sends a voltage level to the phase inverter circuit 12 via the current limiting switch 231 for carrying out current limiting.

Referring back to FIG. 4, the multi-functional speed control circuit 40 is serially connected to the over-current-detecting/current-limiting circuit 20 and the fan motor drive circuit 10 so that the multi-functional speed control circuit 40 is incorporated into the brushless dc motor. Consequently, the brushless dc motor may perform self-PWM control for rotational speed. The multi-functional speed control circuit 40 includes a PWM control circuit 41 and a thermal sensor element 42. The PWM control circuit 41 is consisted of a PWM generator 411 and a multi-functional control circuit 412. The multi-functional speed control circuit 40 is connected between the rotational detective circuit 22 and the current-limiting circuit 23 for obtaining rotational speed signals. The multi-functional control circuit 412 is further connected to the thermal sensor element 42 for obtaining ambient signals. The PWM generator 411 is connected between the current-limiting circuit 23 and the multi-functional control circuit 412, and adapted to generate PWM signals to inject into the current-limiting circuit 23 for controlling the fan motor drive circuit 10. The multi-functional control circuit 412 is connected between the rotational detective circuit 22 and the thermal sensor element 42.

Referring again to FIG. 5, the PWM generator 411 and the multi-functional control circuit 412 of the PWM control circuit 41 is manufactured and contained within a single integrated circuit (IC).

Referring again to FIG. 5, the thermal sensor element 42 is a thermistor that detects ambient temperature and thus sends thermal signals to the multi-functional control circuit 412 of the PWM control circuit 41.

Referring back to FIG. 4, since the multi-functional speed control circuit 40 is provided with the PWM generator 411, it can generate a duty cycle of PWM signal consistent with the specification of the brushless dc motor. Consequently, the current limiting switch 231 of the current-limiting circuit 23 is precisely controlled, as shown in FIG. 5. The multi-functional speed control circuit 40 is able to precisely control the phase inverter circuit 12 of the fan motor drive circuit 10 via the current limiting switch 231.

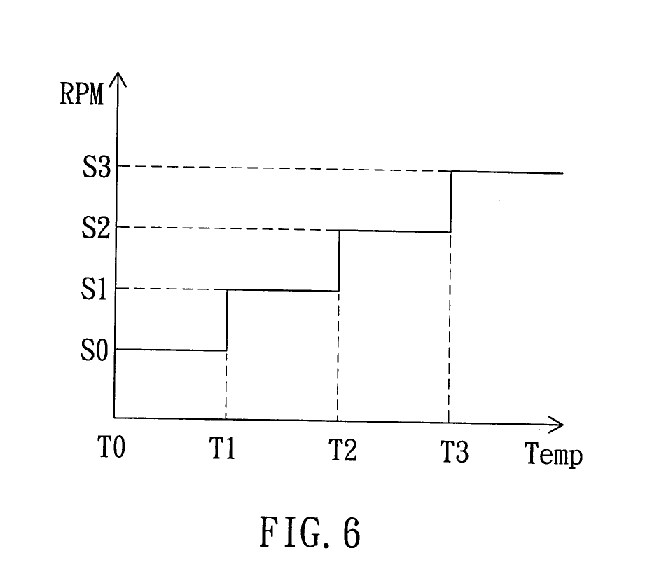

FIG. 6 illustrates a schematic diagram of rotational speed of the brushless dc motor in relation to ambient temperature in accordance with the present invention.

Referring to FIG. 6, once the thermal sensor element 42 is detecting an ambient temperature of T0, T1, T2 and T3, the rotational speed of the fan motor 1 has been precisely operated at a predetermined speed of S0, S1, S2 and S3 under control of the multi-functional speed control circuit 40. Namely, once the thermal sensor element 42 is detecting an increasing temperature T1, the rotational speed of the fan motor 1 has been changed to S1 from S0 in response to increasing of ambient temperature. Contrarily, once the thermal sensor element 42 is detecting an decreasing temperature T0, the rotational speed of the fan motor 1 has been changed to S0 from S1 in response to decreasing of ambient temperature.

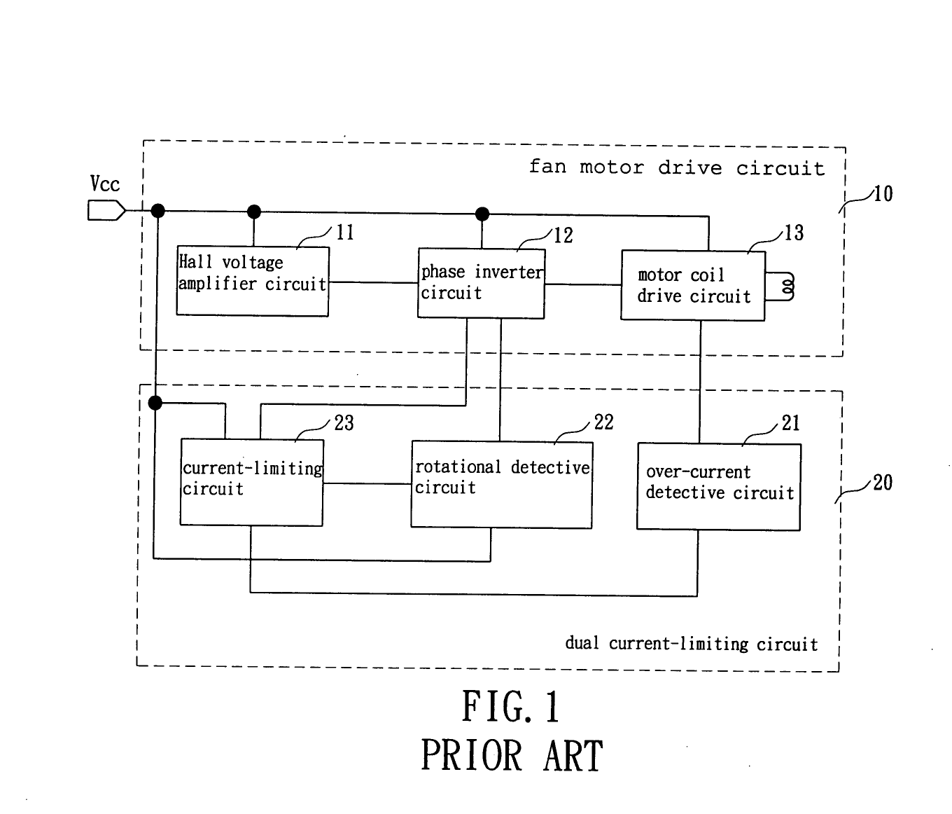

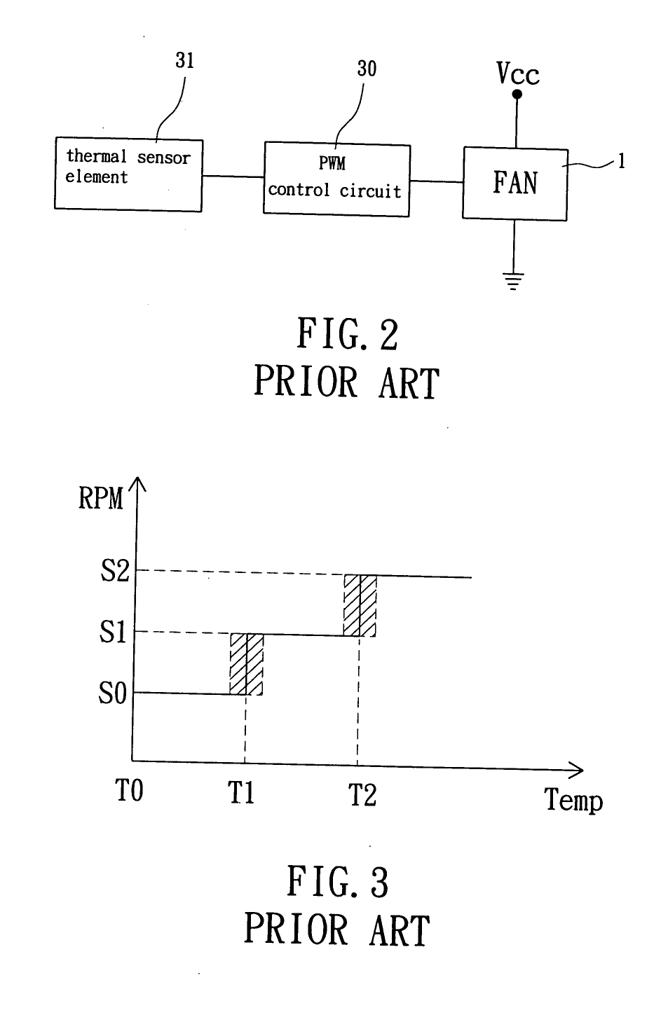

Referring back to FIGS. 1 and 6, the rotational speed of the conventional fan motor 1 cannot change precise that has a previous or delay adjustment when ambient temperature is changed. By contrast, the brushless dc motor having the speed control circuit in accordance with the present invention is able to precisely change the rotational speed by employing the multi-functional speed control circuit 40.

Although the invention has been described in detail with reference to its presently preferred embodiment, it will be understood by one of ordinary skill in the art that various modifications can be made without departing from the spirit and the scope of the invention, as set forth in the appended claims.

1. A speed control circuit for a brushless dc motor, comprising:
a fan motor drive circuit connected with a power source;
an over-current-detecting/current-limiting circuit connected to the motor drive circuit and adapted to detect a rotational speed and an over-current, when the rotational speed is abnormal and the over-current is occurred, the over-current-detecting/current-limiting circuit controls a current at a low voltage level for passing through the fan motor drive circuit; and
a multi-functional speed control circuit connected to the over-current-detecting/current-limiting circuit and adapted to send a predetermined speed signal to control it;
wherein the multi-functional speed control circuit is able to generate PWM signals for precisely controlling the rotational speed.

2. The speed control circuit for the brushless dc motor as defined in claim 1, wherein the over-current-detecting/current-limiting circuit includes an over-current-detecting circuit, a rotational detective circuit and a current-limiting circuit.

3. The speed control circuit for the brushless dc motor as defined in claim 1, wherein the multi-functional speed control circuit includes a PWM control circuit and a thermal sensor element.

4. The speed control circuit for the brushless dc motor as defined in claim 3, wherein the PWM control circuit is consisted of a PWM generator and a multi-functional control circuit.

5. The speed control circuit for the brushless dc motor as defined in claim 4, wherein the multi-functional speed control circuit is connected to the thermal sensor element and further connected to a rotational detective circuit of the over-current-detecting/current-limiting circuit.

6. The speed control circuit for the brushless dc motor as defined in claim 3, wherein the thermal sensor element is a thermistor.

7. The speed control circuit for the brushless dc motor as defined in claim 1, wherein the multi-functional speed control circuit is connected between an over-current-detecting circuit and a rotational detective circuit of the over-current-detecting/current-limiting circuit.

8. The speed control circuit for the brushless dc motor as defined in claim 1, wherein the fan motor drive circuit includes a Hall voltage amplifier circuit, a phase inverter circuit, and a motor coil drive circuit.
